(19) United States
(12) Patent Application Publication
(10) Pub. No.: US 2014/0195673 A1
(43) Pub. Date: Jul. 10, 2014

(54) DYNAMICALLY BALANCING EXECUTION RESOURCES TO MEET A BUDGET AND A QoS of PROJECTS

(71) Applicant: HEWLETT-PACKARD DEVELOPMENT COMPANY, L.P., Houston, TX (US)

(72) Inventors: Nigel T. Cook, Boulder, CO (US); Paolo Faraboschi, Barcelona (ES); Dejan S. Milojicic, Palo Alto, CA (US)

(73) Assignee: HEWLETT-PACKARD DEVELOPMENT COMPANY, L.P., Houston, TX (US)

(21) Appl. No.: 13/738,346

(22) Filed: Jan. 10, 2013

(51) Int. Cl. H04L 29/08

(52) U.S. Cl. CPC H04L 29/08243; H04L 43/04
USPC 709/224

(57) ABSTRACT

Systems, methods, and machine-readable and executable instructions are provided for dynamically balancing execution resources to meet a budget and/or a QoS of projects. An example method can include analyzing a submitted program for a project, where the program comprises data to execute the project and a specification for the project, determining a computing resource allocation based upon the submitted data and the specification, and deploying for execution the submitted data to the determined computing resource allocation. The method can include monitoring progress during the execution of the data to determine a probability of project completion satisfying the specification, and dynamically balancing the execution resources to meet the budget and/or the QoS of the project to satisfy the specification.

### BACKGROUND

Cloud computing is targeting contributions to areas expanding beyond the previously targeted web and enterprise environments. For instance, computational contributions may be made to various scientific areas, such as biology, chemistry, physics, and medicine, etc., in addition to a number of other areas. Perceived “unlimited” resources of the cloud, flexibility in using the resources, and a pay-as-you-go business model are some appealing features. However, large-scale scientific experiments, for instance, may involve simultaneous usage of many computing, networking, and/or storage resources, which may not be handled well by available cloud management engines.

### BRIEF DESCRIPTION OF THE DRAWINGS

FIG. 1 illustrates a diagram of an example of a system for dynamically balancing execution resources to meet a budget and/or a quality of service (QoS) of projects according to the present disclosure.

FIG. 2 is a flow chart illustrating an example of dynamically balancing execution resources to meet the budget and/or the QoS of projects according to the present disclosure.

FIG. 3 is a flow chart illustrating an example of refining a program according to the present disclosure.

FIG. 4 is a flow chart illustrating an example of monitoring indicators according to the present disclosure.

FIG. 5 illustrates a block diagram of an example method for dynamically balancing execution resources to meet the budget and/or the QoS of projects according to the present disclosure.

FIG. 6 illustrates a block diagram of an example of a cloud system for dynamically balancing execution resources to meet the budget and/or the QoS of projects according to the present disclosure.

### DETAILED DESCRIPTION

Some opportunities for expansion of cloud computing may reside in overcoming issues related to interfaces geared toward provisioning individual servers, such as what most Infrastructure-as-a-Service (IaaS) offerings provide. Other issues may be overcoming lack of support to enforce performance and/or cost constraints (e.g., guarantees, restrictions, etc.), which may be of particular concern for small and midsized businesses and/or startups. Some available cloud computing environments may offer some ability to hide low-level infrastructure details to simplify a user experience, but these environments may not enforce constraints for a project upon a budget (e.g., time and/or cost of performance) and/or a QoS (e.g., execution performance, such as throughput of producing usable results).

The present disclosure describes specifying and enforcing budgets and/or QoS of execution of a program for a project, which can include coordination of a plurality of computing resources (e.g., in the cloud). Accordingly, a scientist, for example, can focus upon advancement of research and/or input of resultant data, while an automated engine can handle economics and/or efficiency of analysis (e.g., computation) of the research results (e.g., data) the scientist provides.

Examples of the present disclosure include systems, methods, and machine-readable and executable instructions for dynamically balancing execution resources to meet the budget and/or the QoS of projects. An example method can include analyzing a submitted program for a project, where the program can include data to execute the project and a specification for the project, determining a computing resource allocation based upon the submitted data and the specification, and deploying for execution the submitted data to the determined computing resource allocation. The method can include monitoring progress during the execution of the data to determine a probability of project completion satisfying the specification, and dynamically balancing the execution resources to meet the budget and/or the QoS of the project to satisfy the specification.

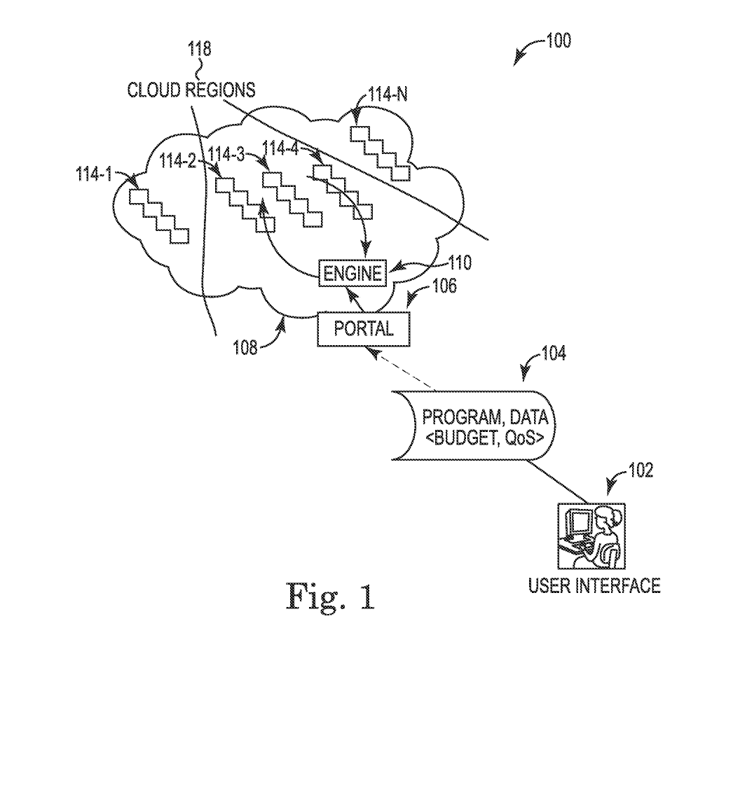

FIG. 1 illustrates a diagram of an example of a system for dynamically balancing execution resources to meet the budget and/or the QoS of projects according to the present disclosure. In the detailed description of the present disclosure, reference is made to the accompanying drawings that form a part hereof and in which is shown by way of illustration how examples of the disclosure may be practiced. These examples are described in sufficient detail to enable one of ordinary skill in the art to practice the examples of this disclosure and it is to be understood that other examples may be utilized and that process, electrical, and/or structural changes may be made without departing from the scope of the present disclosure. As used herein, “a” or “a number of” an element and/or feature can refer to one or more of such elements and/or features. Further, where appropriate, as used herein, “for example’ and “by way of example” should be understood as abbreviations for “by way of example and not by way of limitation”.

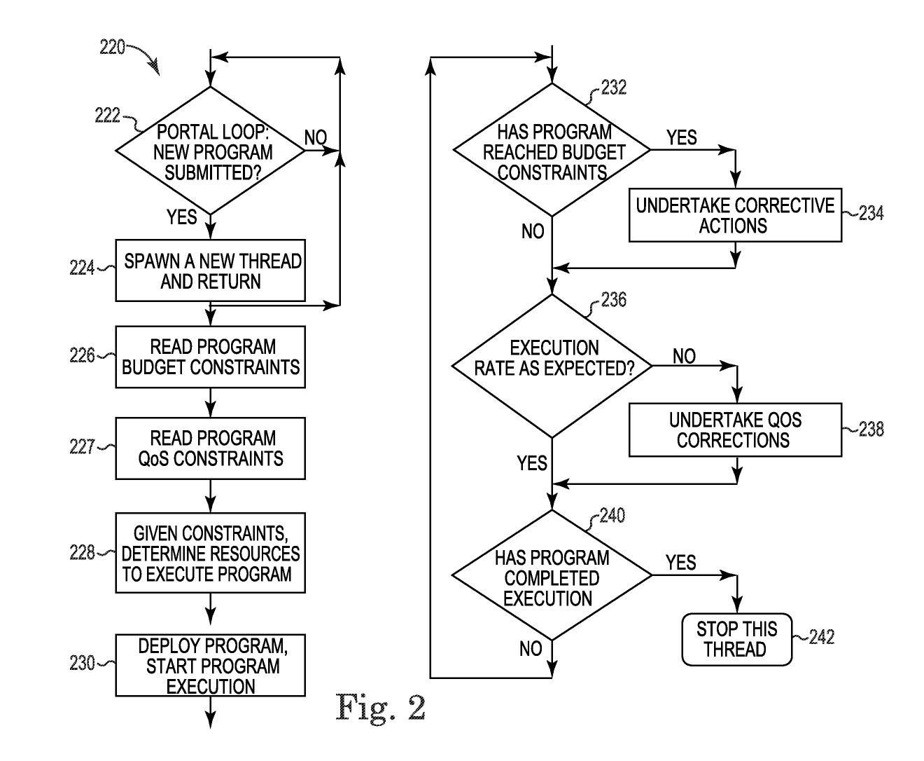

The figures herein follow a numbering convention in which the first digit or digits correspond to the drawing figure number and the remaining digits identify an element or component in the drawing. Similar elements or components between different figures may be identified by the use of similar digits. For example, 111 may reference element “11” in FIG. 1, and a similar element may be referenced as 211 in FIG. 2. Elements shown in the various figures herein may be added, exchanged, and/or eliminated so as to provide a number of additional examples of the present disclosure. In addition, the proportion and the relative scale of the elements provided in the figures are intended to illustrate the examples of the present disclosure and should not be taken in a limiting sense.

Execution of, for example, a scientific program (e.g., on large amounts of data, many experiments, and/or involving complex computations) in an IaaS cloud may utilize an extensive number of computing resources without providing expected performance benefits. Without a coordinated, closed-loop, control engine (e.g., as shown at 110 in FIG. 1), allocation of such resources may be manual and/or driven by up-front and/or static user choices, which may be ineffective in dealing real-time with enforcing budget and/or QoS constraints and/or dynamically balancing (e.g., rebalancing) the execution resources to meet the budget and/or the QoS of projects. The progress of program execution may not meet various QoS targets, which may occur, for example, when the user is over-concerned about the budget and over-limits the resources.

In contrast, as described herein, resource allocation targets can be connected to budget targets to continuously (e.g., periodically) balance the resource allocation choices with the budget target. Accordingly, an engine, as described herein, can automatically balance (e.g., rebalance) the resources to, when feasible, meet the budget and/or QoS targets or can advise the user when such balancing is not feasible (e.g., to present a number of options for completion of the program, the options being influenced by the initial budget and/or QoS targets). Accordingly, the present disclosure describes dynamically balancing execution resources to meet a budget and/or a QoS of projects.

As illustrated in FIG. 1, an example of a system 100 for dynamically balancing the execution resources to meet the budget and/or the QoS of projects can include a user interface 102 for input 104 of a program (e.g., including budget and/or QoS constraints, as described herein) and data to define a project to a portal 106 of a cloud 108. The input 104 to the portal 106 can be directed to an engine 110 that allocates tasks (e.g., jobs) to be performed on the input 104 to various applications 114-1, 114-2, 114-3, 114-4, . . . , 114-N in the cloud 108 appropriate to performance of the particular tasks. For example, various types of tasks may be more appropriately performed by applications running inside virtual machines (VMs) associated with particular servers (e.g., accessible in various cloud regions 118).

The engine 110 can detect that particular tasks of a program are to be mapped onto (e.g., allocated to) a plurality of execution resources (e.g., VMs) based at least partially upon the budget and/or QoS constraints of the input 104 (e.g., cost and/or performance objectives specified by a user through the user interface 102). For example, the engine 110 can be accessed through a web portal 106 to implement a Platform-as-a-Service (PaaS) application to support batch applications and direct computation to appropriate resources provisioned through a lower-level IaaS system.

For example, a user (e.g., a scientist) can input 104 a program, data, and specification information on targeted budget and/or QoS for the program execution in the cloud 108. The engine 110 accessed via the portal 106 can interpret the input 104 and control program execution according to the budget and/or QoS constraints. During program execution, checks can be performed to determine, for example, whether the budget is approaching exhaustion and/or whether a rate of progress of program completion complies with QoS expectations, among many other checks. Such checks can be utilized to determine a probability (e.g., a trend, a likelihood, etc.) that the program of the project will be completed such that the budget and/or QoS targets are satisfied. Based upon results of these checks, adjustments (e.g., corrections) can be made by the engine 110 to facilitate compliance with the budget and/or QoS targets.

The present disclosure describes mechanisms by which the engine 110 can monitor progression of the program, can extract relevant metrics (e.g., percentage of program completion, usage of CPU, networking, and/or storage, and/or latency of interaction, among other performance-related metrics), and/or can periodically resize execution resources in the cloud (e.g., by adding and/or removing VMs, migrating to more powerful VMs, VMs with additional cores, and/or VMs with additional memory, and other resource manipulations in the various cloud regions 118) to facilitate compliance with a target budget and/or QoS profile. Such corrections can, for example, take into account rate of execution (e.g., a QoS constraint) of the program and/or portions thereof in order to determine whether such rates should be maintained, slowed, and/or accelerated (e.g., consistent with budget constraints) by, for example, the adding, removing, migrating, etc., of the VMs.

Instructions to enable such actions (e.g., via a number of processors in a processing resource) can be encoded into a specification for the program. Such a specification is shown below by way of example and not by way of limitation.

```
<budget name=“CloudServiceBudget” description =“Available Budget for Executing Cloud
Service”>
<finance>
    <overall> 150 </overall>
    <initial> 50 </initial>
    <rate> 1 </rate>
</finance>
<execTime>
  <overall> 100 </overall>
    <fragments>3</fragments>
    <fragment1> 20 </fragment1>
    <fragment2> 80 </fragment2>
    <fragment3> 20 </fragment3>
</execTime>
<correctiveActionOverall>
    <action1>inform</action1>
    <action2>slowdown</action2>
  <action3>stop</action3>
</correctiveActionOverall>
<preferredQoS>
    <rateOfExecutionRegular>regularVM</rateOfExecutionRegular>
    <rateOfExecutionSlowed>doubleVM</rateOfExecutionSlowed>
    <rateOfExecutionAccelarate>tinyVM</rateOfExecutionAccelarate>
    <rateOfExecutionClusterHPC>10</rateOfExecutionClusterHPC>
</preferredQoS>
</budget>
```

Accordingly, a computing system for dynamically balancing the execution resources to meet the budget and/or the QoS of projects can include a memory and a processor resource coupled to the memory. The computing system (e.g., the engine 110 described with regard to FIG. 1) can analyze (e.g., read) a submitted program for a project in a cloud, where the program can include data to execute the project, an intended budget, and an intended QoS. The computing system can determine a computing resource allocation in the cloud based upon the submitted data, the intended budget, and/or the intended QoS and can deploy for execution in the cloud the submitted data to the determined computing resource allocation. The computing system can track performance of the submitted program in the cloud to determine a probability of project completion satisfying the intended budget and/or the intended QoS and can take corrective action to dynamically balance the execution resources to meet the budget and/or the QoS of the project, for example, to meet project preferences.

Project preferences can, for example, be determined as a preference for performance versus cost, or vice versa, and their relative importance (e.g., relativity expressed as a ratio, among other representations of the relative importance). For example, a user may prefer to trade off performance for a lower cost. This can be defined as a formula of both performance (e.g., a QoS constraint) and cost (e.g., a budget constraint) that the engine continuously monitors to dynamically balance the execution resources to meet the budget and/or the QoS of the project according to project preferences.

The program can be submitted to an engine in the cloud that executes the previously stated functions, in addition to taking corrective action to dynamically balance the execution resources to meet the budget and/or the QoS of the project according to user inputted project preferences. To track the performance of the submitted program can, in various examples, include to track throughput of the data in a number (e.g., a plurality) of VMs as a QoS consideration. The system can include a number of user interfaces, in various examples, to submit the program for the project and/or to authorize the corrective action to dynamically balance the execution resources to meet the budget and/or the QoS.

Accordingly, functionalities of the present disclosure include mechanisms to track the progression of the program to identify resource resizing strategies and mechanisms to resize the allocation of resources to the program. The engine described with regard to FIG. 1 can, in various examples, perform and/or control either one, or both, of the mechanisms to adjust the resources allocated to the program. At any point in time when these functionalities are utilized (e.g., continuously, periodically, etc.), the engine can adjust (e.g., reallocate, resize, etc.) the resources along at least three different axes. The engine can scale up (e.g., vertically) by, for example, adding more processing cores, network bandwidth, memory, and/or storage bandwidth to applications (e.g., VMs, containers, and/or physical nodes, etc.) for program execution. Scaling up can assist in execution of programs involving, for example, tightly coupled threads of computation operating under a shared memory. The engine can further scale out (e.g., horizontally) by, for example, adding more units of program execution. In some examples, resources can be hot-plugged to increase performance. For example, a message passing interface (MPI), along with a middleware library, can enable hot-plugging of the resources. Scaling out can assist in execution of programs involving, for example, parallelism and/or an increase in parallelism (e.g., a program running on a plurality of VMs and/or an increased number of VMs). In addition, the engine can find, add, and/or substitute execution resources having higher single-thread performance (e.g., newer central processing units (CPUs), CPUs associated with higher processing speeds, etc.). The higher single-thread performance can assist in execution of programs involving, for example, faster single thread performance of each execution thread, as described herein.

In some examples, the engine can analyze (e.g., read) a user-determined specification that includes an initial budget target for program execution (e.g., a cost expressed in monetary units, such as dollars) and/or an initial QoS target for the execution (e.g., expressed as a total execution time, a throughput of execution, etc.). In some examples, the specification can include a set of corrective actions to take, for example, once a budget expires or the program has a low probability of completion while satisfying the initial budget and/or QoS targets (e.g., the budget reaches a particular threshold of expiration with at least a particular percentage of the program remaining uncompleted, etc.). Such corrective actions can, for example, include stopping execution of the program, adjusting the resources, informing the user ahead of expiration, and/or advising the user of alternative strategies for program execution, among other potential corrective actions.

During execution of the program, the engine can compare target metrics (e.g., percentage of program completion, usage of CPU, networking, and/or storage, and/or latency of interaction, among other performance-related metrics) to the extracted metrics, as described herein, and can adjust the resources to better match the target metrics. In various examples, types of resource adjustments can depend on the type of program being executed and/or whether intermediate results are intended, among other considerations.

Expected execution times and/or a rate of execution (e.g., throughput) of the whole program and/or portions thereof can, for example, be estimated from previous program executions. The user can, in various examples, be provided with a number of options to choose from (e.g., a spectrum ranging from low-cost and long-execution-time to high-cost and short-execution-time within the budget constraints) or the user can simply express the constraint as “as fast as possible within the budget”.

The engine can perform its functions in the cloud (e.g., as a backend of a web portal). One of such functions can be to determine an initial resource allocation (e.g., how much memory, how many computing cores and/or VMs and/or of what size, etc.) that the program should start using. The engine can then map and/or deploy the program and/or the submitted data for execution to the initial resource allocation (e.g., into an appropriate set of VMs). Such functions can include continuously (e.g., periodically) tracking performance progress of the program with an intent to maintain execution of the program to be within the budget and/or QoS constraints. Because there can be multiple budget constraints (e.g., relating to cost and/or time of execution of various functions) and there can be multiple QoS constraints (e.g., relating to various factors of resource performance, allowability of usage of various possible resources, etc.), balancing can, in various examples, be performed within each of the budget and/or the QoS considerations. Alternatively or in addition, the balancing can be performed between the budget and the QoS by rebalancing one versus the other.

The engine can perform and/or direct execution of specified corrective actions during execution of the program and/or upon expiration of the budget. As one example of such a corrective action, the engine can direct that execution of the program is stopped and that all output of program execution to that time point is collected. Another example of such corrective action can be the engine determining a strategy for effectively scaling up or scaling out the resources when QoS constraints are about to be violated. In some examples, the QoS constraints can be established within Service Level Agreements (SLAs) between the user and a provider of the service for dynamically balancing the execution resources to meet the budget and/or the QoS of projects.

FIG. 2 is a flow chart illustrating an example of dynamically balancing the execution resources to meet the budget and/or the QoS of projects according to the present disclosure. The flow chart 220 shown in FIG. 2 illustrates an example consistent with the previous description, although various other functions described herein can be added to or substituted for those included in the flow chart 220.

Unless explicitly stated, the functions described herein are not constrained to a particular order or sequence. Additionally, some of the described examples, or elements thereof, can be performed at the same, or substantially the same, point in time. In some examples, a plurality of functions can be grouped together into a package intended to be run together (e.g., substantially simultaneously or sequentially) and/or in the same context (e.g., on the same or similar resource configurations). As described herein, the actions, functions, calculations, data manipulations and/or storage, etc., can be performed by execution of non-transitory machine readable instructions stored in a number of memories (e.g., software, firmware, and/or hardware, etc.) of a number of engines, resources, and/or applications. As such, a number of computing resources with a number of user interfaces can be utilized for dynamically balancing the execution resources to meet the budget and/or the QoS of projects (e.g., via accessing the number of computing resources in the cloud via the engine).

Accordingly, a flow can begin with a portal 222 contributing to a loop for determining whether a new program has been submitted. In some examples, the portal 222 can also determine whether data for processing has been submitted with the program. If the answer to one or both of these determinations is “no”, the loop can return to the beginning. If the answer to one or both of these determinations is “yes”, the loop can proceed to spawning a new thread 224 for program execution and, after doing so, return to the beginning to await another new program.

Preparation for program execution can begin with analysis of the specification. As such, the engine, for example, can read the program budget constraints 226 and can read the program QoS constraints 227, as described herein. Given these constraints, the engine can determine appropriate resources to initiate execution of the program 228, as described herein. The engine can deploy the program to the determined resources to start execution of the program 230, as described herein.

During execution of the program, checks can be performed to determine whether the program has reached and/or is approaching a number of budget constraints 232, as described herein. If an answer to one or more of these determinations is “yes”, the engine can undertake (e.g., perform and/or direct) corrective actions 234, as described herein. If an answer to one or more of these determinations is “no”, the engine can perform and/or direct that checks be performed to determine whether execution of the program or portions thereof are at expected rates 236 (e.g., within ranges consistent with the QoS constraints), as described herein. If an answer to one or more of these determinations is “no”, the engine can undertake (e.g., perform and/or direct) QoS corrective actions 238, as described herein.

If an answer to one or more of these determinations is “yes”, the engine can determine whether execution of the program has been completed 240, as described herein. If the answer to the determination of program completion is “yes”, the engine can stop the thread for program execution 242, as described herein. If the answer to the determination of program completion is “no”, the engine can direct continuation of program execution and the just-described checks and/or corrective actions can continue to be performed until the answer to the determination of program completion is “yes” and the engine stops the thread for program execution 242.

The engine described herein can be implemented as a distributed cloud application for control of utilizing an unlimited number of resources. For example, the engine can control execution of an unlimited number of unrelated or interrelated threads each utilizing an appropriate selection of resources from the unlimited number of resources. The engine can collect various metrics, as described herein, for each of the execution threads, and can continuously (e.g., periodically) enable adjustments based on, for example, the budget and/or QoS constraints of each of the threads. The engine can make decisions to, for example, trade off cost for execution time and/or speed of convergence toward program completion, such that the engine can decide whether to speed up, slow down, or retain program execution as is.

A user and/or an operator can specify, for example, preferences (e.g., a preference for performance versus cost, or vice versa, as described herein), monitoring of program-specific metrics (e.g., percentage of program completion, usage of CPU, networking, and/or storage, and/or latency of interaction, among other performance-related metrics), monitoring of attributes that measure a size and/or a number of contributors (e.g., VMs, containers, and/or physical nodes, etc.) to program completion, and/or markers indicative of execution of functions encoded in the submitted program. Such indicators can also be indicative of marking completion of portions of a program.

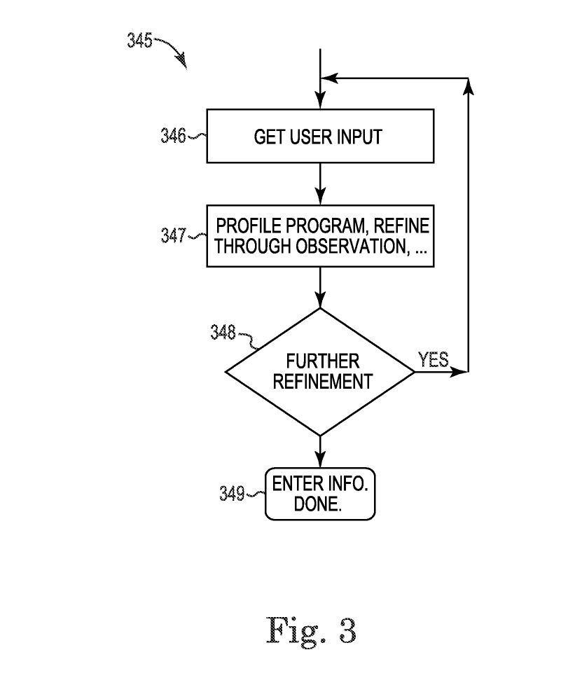

FIG. 3 is a flow chart illustrating an example of refining a program according to the present disclosure. The flow chart 345 shown in FIG. 3 illustrates an example consistent with the description herein, although various other functions described herein can be added to and/or substituted for those included in the flow chart 345.

Utilizing the indicators previously described herein, the engine can monitor progress of program execution and/or can adjust resource usage. One or more of such indicators may not be applicable to a particular program. However, progress of program execution can be determined (e.g., estimated) in a number of alternative and/or additional ways. Lacking one or more such indicators, the engine can estimate progress of the program based on previous experiences of program execution and/or patterns of execution of program-independent metrics (e.g., that there are 30 iterations of execution per file access, among other such program-independent metrics). For example, one or more indicative programs can be synthetically probed and/or observed and for each program and/or program class ranges of “normal” indicator values can be determined, along with corresponding corrective actions for variations outside of these ranges.

Alternatively or in addition, machine-executed learning techniques can be applied to a set of attributes (e.g., file sizes, parameter values, observed values, etc.) to heuristically determine how to derive execution time predictors for different services and/or workloads. Alternatively or in addition, markers encoded in the program (e.g., implemented by user input), transitions between command execution steps, file growth rates, and/or mined statements from log and/or other output files can be observed and/or analyzed to determine execution rate estimates. Particularly in iterative programs, convergence can be modeled by an exponential decay and a difference in slope between samples, as well as sample values, can be used to determine the progress and/or the projected end point of the program.

Accordingly, a flow can begin with getting user input 346 (e.g., a specification for a program, data, etc.) and a program can be profiled and refined through observation 347 (e.g., via user input and/or via analysis and/or corrective actions by the engine), as described herein. Further refinement of the program 348 can enable program completion (e.g., when the engine does not satisfy budget and/or QoS constraints by rebalancing the resources). When a decision for such further refinement 348 is made (e.g., by the engine), the flow can loop back to the beginning to get further user input 346 (e.g., to input a preference for performance versus cost, or vice versa, as described herein). The further user input 346 can, in some examples, revise the budget and/or QoS constraints of the specification.

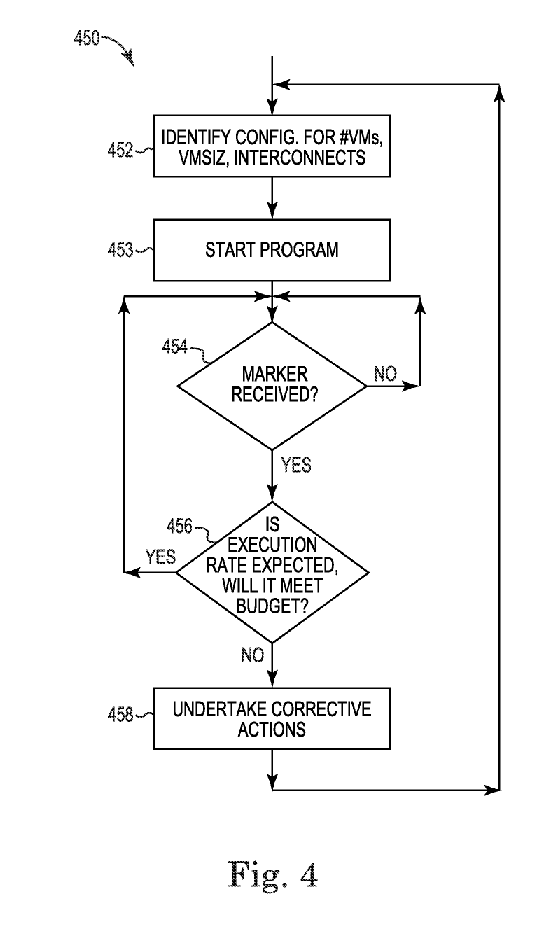

FIG. 4 is a flow chart illustrating an example of monitoring indicators according to the present disclosure. The flow chart 450 shown in FIG. 4 illustrates an example consistent with the description herein, although various other functions described herein can be added to and/or substituted for those included in the flow chart 450.

As described herein, a flow can begin with an engine identifying a configuration 452 (e.g., allocation) of, for example, a number of VMs, sizes of VMs, and/or interconnects between the VMs (e.g., in the cloud), among other such parameters, appropriate for program execution. Following allocation of the program and/or portions thereof to the configuration, the program execution can start 453.

In some examples, as described herein, markers indicative of execution of functions encoded in the submitted program can be monitored (e.g., by the engine) to determine progress toward completion of the program. An example of such markers is shown below by way of example and not by way of limitation. Whereas such markers can be explicitly encoded, in some example the engine can deduce the markers from program behavior.

initiation_phase( )

send_marker(1)

Computation_phase( )

send_marker(2)

communication_phase( )

send_marker(3)

computation_phase( )

send_marker(4)

Write_results

Accordingly, the engine can monitor (e.g., record) whether and/or when markers are sent and/or received 454. If no marker has been received, or if a subsequent marker has not yet been received, the program can loop back to await receipt of such markers. If such a marker has been received, a determination 456 can be made (e.g., by the engine) whether the program is progressing at an expected rate (e.g., consistent with QoS constraints, among other considerations, as described herein) and/or whether completion of the program is projected to meet the budget (e.g., consistent with budget constraints, among other considerations, as described herein). If an answer to one or more of these determinations is “yes”, the program can loop back to await receipt of more such markers. If an answer to one or more of these determinations is “no”, the engine can undertake (e.g., perform and/or direct) corrective actions 458, as described herein.

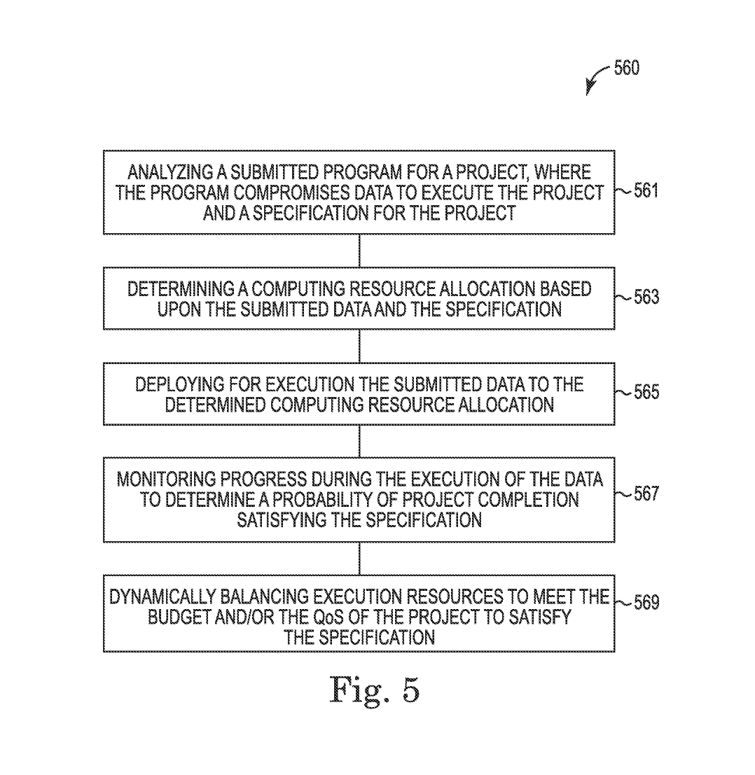

FIG. 5 illustrates a block diagram of an example of a computer-implemented method for dynamically balancing the execution resources to meet the budget and/or the QoS of projects according to the present disclosure. Unless explicitly stated, the method elements described herein are not constrained to a particular order or sequence. Additionally, some of the described examples, or elements thereof, can be performed at the same, or substantially the same, point in time.

As described in the present disclosure, the computer-implemented method 560 for dynamically balancing the execution resources to meet the budget and/or the QoS of projects can include analyzing (e.g., reading) a submitted program for a project, where the program can include data to execute the project and a specification for the project, as shown in block 561. A computing resource allocation can, in various examples, be determined based upon the submitted data and the specification, as shown in block 563. Block 565 shows deploying for execution the submitted data to the determined computing resource allocation. As described herein, progress can be monitored during the execution of the data to determine the probability of project completion satisfying the specification, as shown in block 567. Based at least partially thereon, the execution resources to meet the budget and/or the QoS of the project can be dynamically balanced (e.g., rebalanced) to satisfy the specification, as shown in block 569.

In various examples, the previously stated functions can be executed as instructed by computer-implemented machine-readable instructions (e.g., as stored on a non-transitory machine-readable medium). In some examples, the method can include a user submitting the program (e.g., through a portal to the cloud with access to the engine, as described with regard to FIG. 1).

In various examples, dynamically balancing the execution resources to meet the budget can include dynamically increasing or decreasing a cost of the project (e.g., taking into account budget constraints and/or user input as further refinement, among other considerations), as described herein. In various examples, dynamically balancing the execution resources to meet the QoS can include dynamically increasing or decreasing the computing resource allocation (e.g., taking into account QoS constraints and/or user input as further refinement, among other considerations), as described herein. In some examples, dynamically increasing the computing resource allocation can include scaling out the computing resource allocation and/or scaling up the computing resource allocation, as described herein.

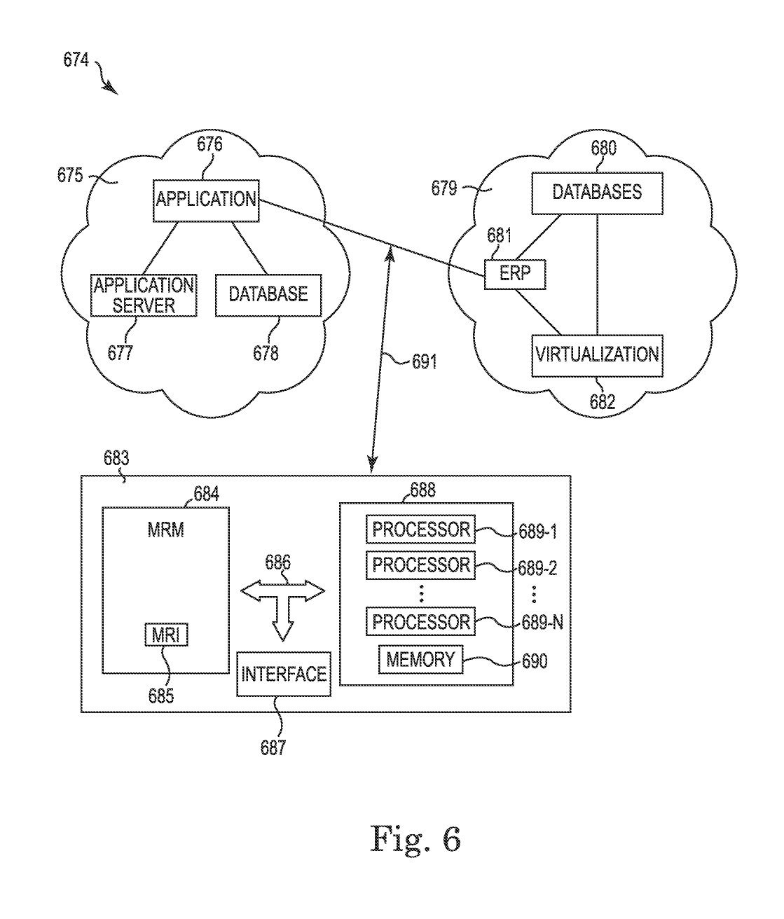

FIG. 6 illustrates a block diagram of an example of a cloud system for dynamically balancing the execution resources to meet the budget and/or the QoS of projects according to the present disclosure. An example system for dynamically balancing the execution resources to meet the budget and/or the QoS of projects is described below as being implemented in the cloud by way of example and not by way of limitation. That is, in some examples of the present disclosure, dynamically balancing the execution resources to meet the budget and/or the QoS of projects can be performed (e.g., at least partially) within an organization utilizing applications, as described herein, accessible and usable through wired communication connections, as opposed to through wireless communication.

In some examples, the system 674 illustrated in FIG. 6 can include a number of cloud systems. In some examples, the number of clouds can include a public cloud system 675 and a private cloud system 679. For example, an environment (e.g., an information technology (IT) environment for a system operator for dynamically balancing the execution resources to meet the budget and/or the QoS of projects) can include a public cloud system 675 and a private cloud system 679 that can include a hybrid environment and/or a hybrid cloud. A hybrid cloud, for example, can include a mix of physical server systems and dynamic cloud services (e.g., a number of cloud servers). For example, a hybrid cloud can involve interdependencies between physically and logically separated services consisting of multiple systems. A hybrid cloud, for example, can include a number of clouds (e.g., two clouds) that can remain unique entities but that can be bound together.

The public cloud system 675, for example, can include a number of applications 676 (e.g., selected from a number of portals, engines, resources, and/or other applications, as described herein), an application server 677, and a database 678. The public cloud system 675 can include a service provider (e.g., the application server 677) that makes a number of the applications 676 and/or resources (e.g., the database 678) available (e.g., to personnel such as operators and/or users, among others) over the Internet, for example. The public cloud system 675 can be free or offered for a fee. For example, the number of applications 676 can include a number of resources available to the public over the Internet. Personnel can access a cloud-based application through a number of interfaces 687 (e.g., via an Internet browser). An application server 677 in the public cloud system 675 can include a number of virtual machines (e.g., client environments) to enable dynamically balancing of the execution resources to meet the budget and/or the QoS of projects, as described herein. The database 678 in the public cloud system 675 can include a number of databases that operate on a cloud computing platform.

The private cloud system 679 can, for example, include an Enterprise Resource Planning (ERP) system 681, a number of databases 680, and virtualization 682 (e.g., a number of VMs to enable dynamically balancing of the execution resources to meet the budget and/or the QoS of projects, as described herein). For example, the private cloud system 679 can include a computing architecture that provides hosted services to a limited number of nodes (e.g., computers and/or VMs thereon) behind a firewall. The ERP 681, for example, can integrate internal and external information across an entire business unit and/or organization (e.g., a provider of services for dynamically balancing the execution resources to meet the budget and/or the QoS of projects). The number of databases 680 can include an event database, an event archive, a central configuration management database (CMDB), a performance metric database, and/or databases for a number of applications, among other databases. Virtualization 682 can, for example, include the creation of a number of virtual resources, such as a hardware platform, an operating system, a storage device, and/or a network resource, among others.

In some examples, the private cloud system 679 can include a number of applications and an application server as described for the public cloud system 675. In some examples, the private cloud system 679 can similarly include a service provider that makes a number of the applications and/or resources (e.g., the databases 680 and/or the virtualization 682) available for free or for a fee (e.g., to personnel such as the operator and/or the user, among others) over, for example, a local area network (LAN), a wide area network (WAN), a personal area network (PAN), and/or the Internet, among others. The public cloud system 675 and the private cloud system 679 can be bound together, for example, through one or more of the number of applications (e.g., 676 in the public cloud system 675) and/or the ERP 681 in the private cloud system 679 to enable dynamically balancing of the execution resources to meet the budget and/or the QoS of projects, as described herein.

The system 674 can include a number of computing devices 683 (e.g., a number of IT computing devices, system computing devices, and/or manufacturing computing devices, among others) having machine readable memory (MRM) resources 684 and processing resources 688 with machine readable instructions (MRI) 685 (e.g., computer readable instructions) stored in the MRM 684 and executed by the processing resources 688 to, for example, enable dynamically balancing of the execution resources to meet the budget and/or the QoS of projects, as described herein. The computing devices 683 can be any combination of hardware and/or program instructions (e.g., MRI) configured to, for example, enable the dynamically balancing of the execution resources to meet the budget and/or the QoS of projects, as described herein. The hardware, for example, can include a number of interfaces 687 (e.g., graphic user interfaces (GUIs)) and/or a number of processing resources 688 (e.g., processors 689-1, 689-2, . . . , 689-N), the MRM 684, etc. The processing resources 688 can include memory resources 690 and the processing resources 688 (e.g., processors 689-1, 689-2, . . . , 689-N) can be coupled to the memory resources 690. The MRI 685 can include instructions stored on the MRM 684 that are executable by the processing resources 688 to execute one or more of the various actions, functions, calculations, data manipulations and/or storage, etc., as described herein.

The computing devices 683 can include the MRM 684 in communication through a communication path 686 with the processing resources 688. For example, the MRM 684 can be in communication through a number of application servers (e.g., Java® application servers) with the processing resources 688. The computing devices 683 can be in communication with a number of tangible non-transitory MRMs 684 storing a set of MRI 685 executable by one or more of the processors (e.g., processors 689-1, 689-2, . . . , 689-N) of the processing resources 688. The MRI 685 can also be stored in remote memory managed by a server and/or can represent an installation package that can be downloaded, installed, and executed. The MRI 685, for example, can include a number of modules for storage of particular sets of instructions to direct execution of particular functions, as described herein.

Processing resources 688 can execute MRI 685 that can be stored on an internal or external non-transitory MRM 684. The non-transitory MRM 684 can be integral, or communicatively coupled, to the computing devices 683, in a wired and/or a wireless manner. For example, the non-transitory MRM 684 can be internal memory, portable memory, portable disks, and/or memory associated with another computing resource. A non-transitory MRM (e.g., MRM 684), as described herein, can include volatile and/or non-volatile storage (e.g., memory). The processing resources 688 can execute MRI 685 to perform the actions, functions, calculations, data manipulations and/or storage, etc., as described herein. For example, the processing resources 688 can execute MRI 685 to enable dynamically balancing of the execution resources to meet the budget and/or the QoS of projects, as described herein.

The MRM 684 can be in communication with the processing resources 688 via the communication path 686. The communication path 686 can be local or remote to a machine (e.g., computing devices 683) associated with the processing resources 688. Examples of a local communication path 686 can include an electronic bus internal to a machine (e.g., a computer) where the MRM 684 is volatile, non-volatile, fixed, and/or removable storage medium in communication with the processing resources 688 via the electronic bus. Examples of such electronic buses can include Industry Standard Architecture (ISA), Peripheral Component Interconnect (PCI), Advanced Technology Attachment (ATA), Small Computer System Interface (SCSI), Universal Serial Bus (USB), among other types of electronic buses and variants thereof.

The communication path 686 can be such that the MRM 684 can be remote from the processing resources 688, such as in a network connection between the MRM 684 and the processing resources 688. That is, the communication path 686 can be a number of network connections. Examples of such network connections can include LAN, WAN, PAN, and/or the Internet, among others. In such examples, the MRM 684 can be associated with a first computing device and the processing resources 688 can be associated with a second computing device (e.g., computing devices 683). For example, such an environment can include a public cloud system (e.g., 675) and/or a private cloud system (e.g., 679) to enable dynamically balancing of the execution resources to meet the budget and/or the QoS of projects, as described herein.

In various examples, the processing resources 688, the memory resources 684 and/or 690, the communication path 686, and/or the interfaces 687 associated with the computing devices 683 can have a connection 691 (e.g., wired and/or wirelessly) to a public cloud system (e.g., 675) and/or a private cloud system (e.g., 679). The system 674 can utilize software, hardware, firmware, and/or logic for dynamically balancing the execution resources to meet the budget and/or the QoS of projects, as described herein. The system 674 can be any combination of hardware and program instructions. The connection 691 can, for example, enable the computing devices 683 to directly and/or indirectly control (e.g., via the MRI 685 stored on the MRM 684 executed by the processing resources 688) functionality of a number of the applications 676 accessible in the cloud. The connection 691 also can, for example, enable the computing devices 683 to directly and/or indirectly receive input from the number of the applications 676 accessible in the cloud.

In various examples, the processing resources 688 coupled to the memory resources 684 and/or 690 can execute MRI 685 to enable the computing devices 683 to analyze (e.g., read) a submitted program for a project, where the program includes data to execute the project, an intended budget, and an intended QoS. As described herein, the processing resources 688 coupled to the memory resources 684 and/or 690 can execute MRI 685 to determine a computing resource allocation based upon the submitted data, the intended budget, and the intended QoS and deploy for execution the submitted data to the determined computing resource allocation. In various examples, the processing resources 688 coupled to the memory resources 684 and/or 690 can execute MRI 685 to monitor indicators during the execution of the data to determine a probability of project completion satisfying the intended budget and/or the intended QoS and to dynamically balance the execution resources to meet the budget and/or the QoS of the project according to project preferences.

In various examples, the indicators can include a number of metrics, as described herein, that measure performance of contributors (e.g., of active contributors), as described herein, to the project completion, a number of attributes, as described herein, that measure a size of and/or a number of contributors to the project completion, and/or a number of markers, as described herein, indicative of execution of functions encoded in the submitted program.

Advantages of dynamically balancing the execution resources to meet the budget and/or the QoS of the project, as described herein, include a limitation on a cost incurred by the user. That is, users can be assured that execution of the project (e.g., encoded in the program) in the cloud does not exceed a target budget. The user also can be informed when the execution trend points to a probability of budget exhaustion before completion of the program. Among various other options described herein, execution of the program can be stopped if an upper limit on the budget is reached.

Accordingly, performance of a project can be simplified for a user by reducing concern about exhaustion of the budget prior to project completion because the engine, as described herein, automatically monitors such considerations. As such, user satisfaction can be increased by the engine exerting continuous control over the user's investment in project execution.

As used herein, “logic” is an alternative or additional processing resource to execute the actions and/or functions, etc., described herein, which includes hardware (e.g., various forms of transistor logic, application specific integrated circuits (ASICs), etc.), as opposed to computer executable instructions (e.g., software, firmware, etc.) stored in memory and executable by a processing resource.

As described herein, plurality of storage volumes can include volatile and/or non-volatile storage (e.g., memory). Volatile storage can include storage that depends upon power to store information, such as various types of dynamic random access memory (DRAM), among others. Non-volatile storage can include storage that does not depend upon power to store information. Examples of non-volatile storage can include solid state media such as flash memory, electrically erasable programmable read-only memory (EEPROM), phase change random access memory (PCRAM), magnetic storage such as a hard disk, tape drives, floppy disk, and/or tape storage, optical discs, digital versatile discs (DVD), Blu-ray discs (BD), compact discs (CD), and/or a solid state drive (SSD), etc., as well as other types of machine readable media.

It is to be understood that the descriptions presented herein have been made in an illustrative manner and not a restrictive manner. Although specific examples systems, machine readable media, methods and instructions, for example, for determining UI coverage have been illustrated and described herein, other equivalent component arrangements, instructions, and/or device logic can be substituted for the specific examples presented herein without departing from the spirit and scope of the present disclosure.

The specification examples provide a description of the application and use of the systems, machine readable media, methods, and instructions of the present disclosure. Since many examples can be formulated without departing from the spirit and scope of the systems, machine readable media, methods, and instructions described in the present disclosure, this specification sets forth some of the many possible example configurations and implementations.

What is claimed:

1. A computer-implemented method for dynamically balancing execution resources to meet a budget and/or a quality of service (QoS) of projects, comprising:
analyzing a submitted program for a project, wherein the program comprises data to execute the project and a specification for the project;
determining a computing resource allocation based upon the submitted data and the specification;
deploying for execution the submitted data to the determined computing resource allocation;
monitoring progress during the execution of the data to determine a probability of project completion satisfying the specification; and
dynamically balancing the execution resources to meet the budget and/or the QoS of the project to satisfy the specification.

2. The method of claim 1, comprising executing the previously stated functions as instructed by computer-implemented machine-readable instructions.

3. The method of claim 1, comprising a user submitting the program.

4. The method of claim 1, wherein dynamically balancing the execution resources to meet the budget comprises dynamically increasing or decreasing a cost of the project.

5. The method of claim 1, wherein dynamically balancing the execution resources to meet the QoS comprises dynamically increasing or decreasing the computing resource allocation.

6. The method of claim 5, wherein dynamically increasing the computing resource allocation comprises scaling out the computing resource allocation.

7. The method of claim 5, wherein dynamically increasing the computing resource allocation comprises scaling up the computing resource allocation.

8. A non-transitory machine-readable medium storing a set of instructions for dynamically balancing execution resources to meet a budget and/or a quality of service (QoS) of projects, wherein the set of instructions is executable by a processor to cause a computer to:
analyze a submitted program for a project, wherein the program comprises data to execute the project, an intended budget, and an intended QoS;
determine a computing resource allocation based upon the submitted data, the intended budget, and the intended QoS;
deploy for execution the submitted data to the determined computing resource allocation;
monitor indicators during the execution of the data to determine a probability of project completion satisfying the intended budget and the intended QoS; and
dynamically balance the execution resources to meet the budget and/or the QoS of the project according to project preferences.

9. The medium of claim 8, wherein the indicators comprise a number of metrics that measure performance of contributors to the project completion.

10. The medium of claim 8, wherein the indicators comprise a number of attributes that measure a size of and/or a number of contributors to the project completion.

11. The medium of claim 8, wherein the indicators comprise a number of markers indicative of execution of functions encoded in the submitted program.

12. A computing system for dynamically balancing execution resources to meet a budget and/or a quality of service (QoS) of projects, comprising:
a memory;
a processor resource coupled to the memory, to:
analyze a submitted program for a project in a cloud, wherein the program comprises data to execute the project, an intended budget, and an intended QoS;
determine a computing resource allocation in the cloud based upon the submitted data, the intended budget, and the intended QoS;
deploy for execution in the cloud the submitted data to the determined computing resource allocation;
track performance of the submitted program in the cloud to determine a probability of project completion satisfying the intended budget and the intended QoS; and
take corrective action to dynamically balance the execution resources to meet the budget and/or the QoS of the project.

13. The system of claim 12, wherein the program is submitted to an engine in the cloud that executes the previously stated functions, including to take corrective action to dynamically balance the execution resources to meet the budget and/or the QoS of the project according to user inputted project preferences.

14. The system of claim 12, wherein to track the performance of the submitted program comprises to track throughput of the data in a number of virtual machines as a QoS consideration.

15. The system of claim 12, comprising a number of user interfaces to submit the program for the project and to authorize the corrective action to dynamically balance the execution resources to meet the budget and/or the QoS.
